(19) United States
(12) Patent Application Publication
(10) Pub. No.: US 2004/0074998 A1
(43) Pub. Date: Apr. 22, 2004

(54) Fuel injection valve

(76) Inventors: Franz Rieger, Aalen (DE); Thomas Ludwig, Huenxe (DE); Hans Schlembach, Muehlacker (DE); Gottlob Haag, Markgroeningen (DE); Ulrich Brenner, Moeglingen (DE); Michael Huebel, Gerlingen (DE); Juergen Stein, Illingen (DE); Udo Sieber, Bietigheim (DE)

Correspondence Address: KENYON & KENYON, ONE BROADWAY, NEW YORK, NY, 10004, US

(21) Appl. No.: 10/204,534

(22) PCT Filed: Dec. 15, 2001
(86) PCT No.: PCT/DE01/04748

(51) Int. Cl. B05B 1/30

(52) U.S. Cl. 239/585.1

(57) ABSTRACT

A fuel injector (1), in particular for fuel injection systems in internal combustion engines, including an actuator (27), a valve needle (3) operable by the actuator (27) for operating a valve-closure member (4), which, together with a valve-seat surface (6) forms a sealing seat and a swirl device (34) having at least one swirl channel (35), through which fuel flows with a tangential component relative to a longitudinal axis (38) of the fuel injector (1). The axial position of a plunger element (36) determines a cross-section of at least one bypass channel (37) that bypasses the at least one swirl channel (35) without a tangential component.

### BACKGROUND INFORMATION

The present invention is directed to a fuel injector according to the definition of the species in the main claim.

A fuel injector for the direct injection of fuel into the combustion chamber of a mixture-compressing, spark-ignited internal combustion engine, the fuel injector including a guide and seat area formed by three disk-shaped elements at the downstream end of the fuel injector is known from German Patent Application 197 36 682 A1. A swirl element is embedded between a guide element and a valve seat element. The guide element is used to guide an axially movable valve needle that protrudes through the guide element while a valve closing section of the valve needle cooperates with a valve seat surface of the valve seat element. The swirl element has an inner opening area with multiple swirl channels that are not connected to the outer circumference of the swirl element. The entire opening area extends completely across the axial thickness of the swirl element.

A disadvantage of the fuel injectors known from the publication cited above is in particular the fixedly set swirl angle which cannot be adapted to the different operating states of an internal combustion engine such as partial load and full load operation. As a result, it is also not possible to adapt the cone apex angle α of the injected mixture cloud to the various operating states, which results in non-homogeneities during combustion, increased fuel consumption, as well as increased exhaust gas emission.

### ADVANTAGES OF THE PRESENT INVENTION

In contrast, the advantage of the fuel injector according to the present invention having the characterizing features of the main claim is that the swirl is adjustable as a function of the operating state of the internal combustion engine, making it possible to produce a jet pattern adapted to the operating state of the internal combustion engine. This makes it possible to optimize both the mixture formation and the combustion process.

A particular advantage is the simple design of the swirl-producing components, which in contrast to conventional swirl formation, are only augmented by a plunger element, which is simple to manufacture and which is slidable onto the valve needle. The plunger element may be activated by a suitable control unit, for example by piezoelectric, electromagnetic or hydraulic means.

It is also an advantage that the swirl disk of the conventional swirl formation may be taken over without modification.

The measures cited in the dependent claims make advantageous refinements on and improvements of the fuel injector specified in the main claim possible.

In addition, the funnel-shaped, recessed form of the valve-seat member, which makes it possible to deform the swirl disk elastically and accordingly adjust the swirl, is simple to manufacture.

Advantageously, the downstream end of the plunger element has a radial bevel, whose inclination corresponds to that of the funnel-shaped valve-seat member, as a result of which the swirl disk is uniformly deformed and non-homogeneities are prevented.

Also of advantage is the possibility to switch the plunger element into the position appropriate to the present operating state of the fuel injector independently of the lift of the valve needle.

### DRAWING

An exemplary embodiment of the present invention is depicted in simplified form in the drawing and explained in greater detail in the following description.

FIG. 1 shows an axial section through a first exemplary embodiment of a fuel injector according to the present invention.

FIG. 2 shows an enlarged detail taken from the fuel injector according to the present invention in area II in FIG. 1.

FIGS. 3A-3B show a schematic representation of the jet apex angle α of a mixture cloud injected into the combustion chamber for various operating states of a fuel injector.

FIG. 4 shows a schematic view of an exemplary embodiment of the swirl disk of the fuel injector according to the present invention.

FIGS. 5A-5B show a schematic representation of the function of the fuel injector according to the present invention in area V in FIG. 2.

### DETAILED DESCRIPTION OF THE EXEMPLARY EMBODIMENTS

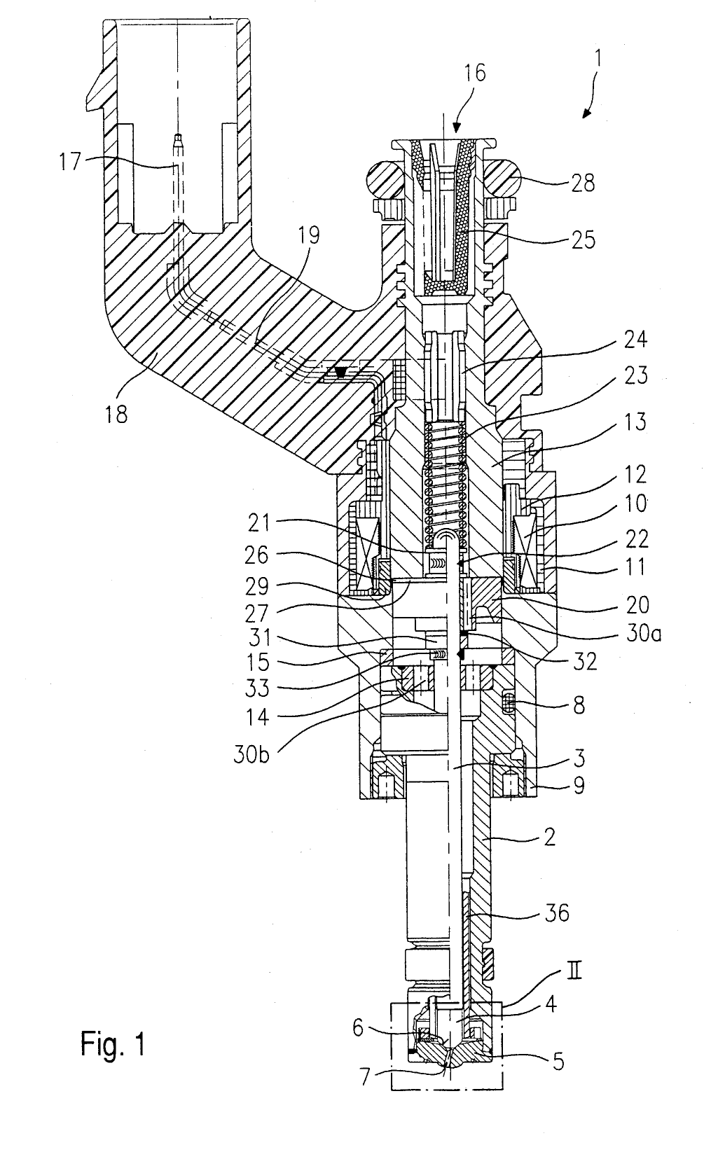

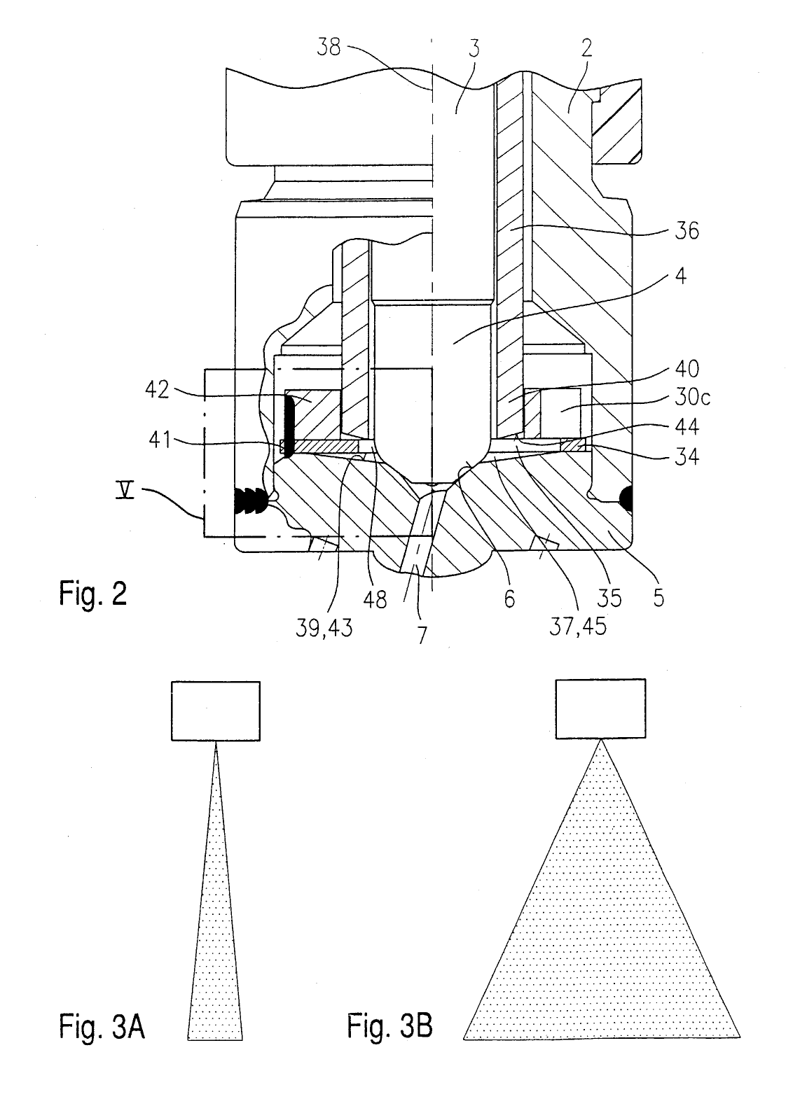

Before an exemplary embodiment of a fuel injector 1 according to the present invention is described in greater detail based on FIGS. 2 through 5, the essential components of fuel injector 1 according to the present invention will be explained briefly in general terms based on FIG. 1.

Fuel injector 1 is designed in the form of a fuel injector for fuel injection systems of mixture-compressing, spark-ignited internal combustion engines. Fuel injector 1 is suitable in particular for the direct injection of fuel into a combustion chamber (not shown) of an internal combustion engine.

Fuel injector 1 includes a nozzle body 2 in which a valve needle 3 is situated. Valve needle 3 is mechanically linked with a valve-closure member 4, which cooperates with a valve seat surface 6 situated on a valve-seat member 5 to form a sealing seat. In the exemplary embodiment, fuel injector 1 is an inwardly opening fuel injector 1 having at least one spray-discharge orifice 7. Nozzle body 2 is sealed off from outer pole 9 of a solenoid 10 by a seal 8. Solenoid 10 is encapsulated in a coil housing 11 and wound on a coil frame 12 which is in contact with an inner pole 13 of solenoid 10. Inner pole 13 and outer pole 9 are separated by a gap 26 and are supported by a connecting component 29. Solenoid 10 is energized by an electric current which may be supplied by an electric plug contact 17 via a line 19. Plug contact 17 is enclosed by a plastic sheathing 18 which may be extruded onto inner pole 13.

Valve needle 3 is guided in a valve needle guide 14 which is designed in the shape of a disk. A matched adjusting disk 15 is used to adjust the lift. An armature 20 is located on the other side of adjusting disk 15. Armature 20 is friction-locked to valve needle 3 via a first flange 21, valve needle 3 being connected to first flange 21 by a weld 22. A restoring spring 23 is supported on first flange 21, which in the present design of fuel injector 1 is pre-stressed by a sleeve 24.

A second flange 31, which is connected to valve needle 3 by a weld 33, is used as a lower armature stop. An elastic intermediate ring 32 which rests on second flange 31 prevents rebounding when fuel injector 1 is closed.

A guide disk 34, having at least one swirl channel 35, is situated on the inlet side of the sealing seat. Together with a sleeve-shaped plunger element 36 in the exemplary embodiment, guide disk 34 produces the swirl formation of the fuel jet, which is a function of the operating state of fuel injector 1. In the exemplary embodiment, plunger element 36 is designed as a hollow cylinder and slipped onto valve needle 3. Using a control unit, which is not shown here, as well as an actuating mechanism, also not shown in greater detail, which, e.g., act on plunger sleeve 36 by electromagnetic, hydraulic or piezoelectric means, it is possible to deform swirl disk 34 elastically during the operation of fuel injector 1 so that a bypass channel 37 is closed and consequently a swirl may be produced in the fuel flowing through swirl disk 34.

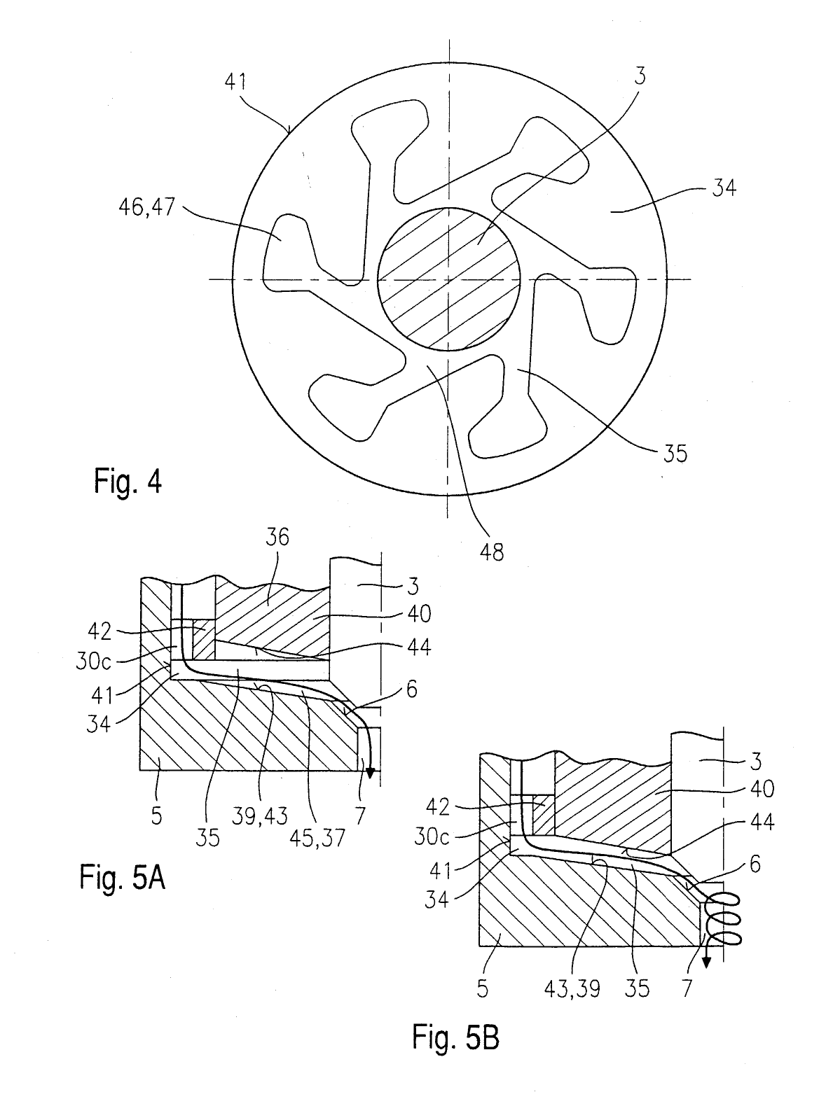

As a result, the fuel flowing through fuel injector 1 in partial load operation has a lesser swirl, whereby a jet apex angle α of a mixture cloud injected into the combustion chamber (not shown) of the internal combustion engine is kept smaller, while in full load operation a greater swirl also produces a larger jet apex angle α. Accordingly, the mixture may be kept richer or leaner, making it possible to achieve optimum combustion. Swirl disk 34 and the plunger element are shown in greater detail in FIGS. 2 and 4 while the mode of operation of the components is explained in FIGS. 5A and 5B.

Fuel channels 30a to 30c run in valve needle guide 14, in armature 20 and in a guide disk 42. The fuel is supplied via a central fuel supply 16 and is filtered through a filter element 25. A seal 28 seals off fuel injector 1 from a fuel line, which is not shown in greater detail.

When fuel injector 1 is in its idle state, restoring spring 23 applies force to armature 20 against the direction of its lift so that valve-closure member 4 is held in sealing contact against valve seat 6. When solenoid 10 is energized, it builds up a magnetic field which moves armature 20 in the direction of its lift against the elastic force of restoring spring 23, the lift being predetermined by a working gap 27 in the idle state, located between inner pole 12 and armature 20. Armature 20 entrains flange 21, which is welded to valve needle 3, also in the lift direction. Valve-closure member 4, which is mechanically linked with valve needle 3, lifts from valve seat surface 6 and the fuel is spray-discharged. Plunger element 36 may be controlled independently of the lift of valve needle 3 and displaced into the axial position appropriate to the particular operating state.

When the coil current is switched off, the pressure of restoring spring 23 causes armature 20 to drop away from inner pole 13 after sufficient decay of the magnetic field, as a result of which flange 21, which is mechanically linked to valve needle 3, moves against the lift direction. This moves valve needle 3 in the same direction, as a result of which valve-closure member 4 settles on valve seat surface 6 and fuel injector 1 is closed.

In a partial, simplified axial sectional view, FIG. 2 shows fuel injector 1 designed according to the present invention in area II of FIG. 1. Elements already described are provided with matching reference symbols in all figures.

In order to implement the aforementioned adjustment of the swirl, fuel injector 1 designed according to the present invention has, in addition to plunger element 36, a funnel-shaped hollow 43 in an inlet-side face 39 of valve-seat member 5. Hollow 43 runs radially from the outside to the inside so that valve seat surface 6 closes hollow 43 off from spray-discharge orifice 7.

At a downstream end 40, plunger element 36 has a bevel 44, the inclination of which corresponds to the inclination of funnel-shaped hollow 43.

If, when fuel injector 1 is open, fuel flows through fuel channel 30c formed in guide disk 42, the fuel receives a more or less strong swirl as a function of the position of plunger element 36.

In FIG. 2, plunger element 36 is in an operating position in which there is no effect on swirl disk 34, which is thus not elastically deformed. As a result, a bypass channel 37 is opened, which makes it possible for the fuel to flow radially from the outside to the inside without taking on a swirl. This is made possible by funnel-shaped hollow 43 in inflow-side face 39 of valve-seat member 5 since it causes a gap 45 to form between swirl disk 34 and valve-seat member 5. The tangential component of the fuel flow is thus very small with the result that the widening of the jet pattern of the mixture cloud injected into the combustion chamber is slight, jet apex angle α remains small and the mixture cloud has a high penetration capacity.

In order to illustrate the requirements for the mixture cloud injected into the combustion chamber for two different operating states of a fuel injector 1 (partial load range and full load range), FIGS. 3A and 3B show the desired mixture cloud formed for each case.

In partial load operation, a mixture-compressing, spark-ignited internal combustion engine places different requirements on the form, the stoichiometry and the penetration capacity of the mixture cloud injected into the combustion chamber than in full load operation. In partial load operation, the mixture cloud, as shown in FIG. 3A, should have a relatively small apex angle α, a high penetration capacity, a narrow core area due to the small apex angle α with a richer mixture and a very lean envelop, while a large apex angle α as shown in FIG. 3B and consequently an almost homogeneous filling of the cylinder with a combustible mixture is required in full load operation.

The measures according to the present invention described here make it possible to model the parameters of the mixture cloud by influencing the swirl. If, for example, the fuel exits from spray-discharge orifice 7 with low swirl, a mixture cloud having a small apex angle α is injected, while a strong swirl produces a large jet widening and accordingly a mixture cloud having a large apex angle α. It is possible to adjust the strength of the swirl through the axial position of plunger element 36.

In a schematic view, FIG. 4 shows an exemplary embodiment of swirl disk 34 of fuel injector 1 according to the present invention.

The shape of swirl disk 34 illustrated in FIG. 4 has six swirl channels 35 which are arranged in a star-shaped pattern with equal spacing. At their radial outer ends 46, swirl channels 35 have widenings 47. Valve needle 3 penetrates swirl disk 34, as a result of which a swirl chamber 48 is created between valve needle 3 and swirl disk 34, into which swirl channels 35 open.

Widenings 47 are designed and arranged in such a way that the fuel flowing through fuel channel 30c enters gap 45 between valve-seat member 5 and swirl disk 34 without taking on a swirl and thus uses bypass channel 37 instead of swirl channels 35. The fuel may thus be spray-discharged without a tangential component, as a result of which the jet has the high penetration capacity required.

In a detailed section of area V of FIG. 2, FIGS. 5A and 5B show schematically the mode of operation of plunger element 36 for swirl formation.

FIG. 5A shows the position of plunger element 36 already illustrated in FIG. 2 in which there is no effect on swirl disk 34 and accordingly no swirling of the fuel. In particular, the matching of the inclination of wedge-shaped bevel 44 of the downstream end 40 of plunger element 36 with funnel-shaped hollow 43 of inflow-side face 39 of valve-seat member 5 is apparent in FIG. 5A.

If fuel injector 1 is opened by operating actuator 10 and lifting valve needle 3 off valve seat surface 6, fuel flows through fuel channel 30c to swirl disk 34. If plunger element 36 is not operated, swirl disk 34 is separated from valve-seat member 5 by gap 45, as a result of which it is possible for the fuel to bypass swirl channels 35 formed in swirl disk 34 and flow via outside radial widenings 47 of swirl channels 35 and through gap 45, or bypass channel 37 thus formed, to the sealing seat without swirl. The flow is indicated in FIG. 5A by an arrow.

FIG. 5B shows fuel injector 1 according to the present invention also in the open state. Compared to FIG. 5A, plunger element 36 is displaced in the downstream direction and presses on swirl disk 34. The matching inclination of bevel 44 and of hollow 43 causes swirl disk 34 to be uniformly elastically deformed by plunger element 36 and pressed against valve-seat member 5, as a result of which bypass channel 37 or gap 45 is closed and the fuel flows though swirl channels 35. As a result, the flow receives a component in the tangential direction causing fuel swirled after the sealing seat to be spray-discharged via spray-discharge orifice 7. This is also indicated in FIG. 5B by an arrow.

The invention is not limited to the exemplary embodiment shown and in particular, it may be used with fuel injectors 1 having piezoelectric or magnetostrictive actuators 27 and with any design variants of fuel injectors 1.

What is claimed is:

1. A fuel injector (1) for fuel injection systems in internal combustion engines, comprising an actuator (10), a valve needle (3) actuatable by the actuator (10) for operating a valve-closure member (4), which, together with a valve-seat surface (6) forms a sealing seat, and a swirl disk (34) having at least one swirl channel (35), through which fuel flows with a tangential component relative to a longitudinal axis (38) of the fuel injector (1), wherein the swirl disk (34) is elastically deformable in an axial direction by the action of a plunger element (36).

2. The fuel injector as recited in claim 1, wherein the axial position of the plunger element (36) determines a cross-section of a bypass channel (37) that bypasses the at least one swirl channel (35) without a tangential component.

3. The fuel injector as recited in claim 1 or 2, wherein the plunger element (36) is formed as a hollow cylinder and may be slipped onto the valve needle (3).

4. The fuel injector as recited in one of claims 1 through 3, wherein one inlet-side face (39) of a valve-seat member (5) has a funnel-shaped hollow (43).

5. The fuel injector as recited in claim 4, wherein the sealing seat forms the lowest point of the funnel-shaped hollow (43) of the face (39) of the valve-seat member (5).

6. The fuel injector as recited in claim 4 or 5, wherein one discharge-side end (40) of the plunger element (36) has a wedge-shaped bevel (44).

7. The fuel injector as recited in claim 6, wherein the wedge-shaped bevel (44) of the discharge-side end (40) of the plunger element (36) has the same inclination as the funnel-shaped hollow (43) of the inlet-side face (39) of the valve-seat member (5).

8. The fuel injector as recited in claim 7, wherein the swirl disk (34) is situated between the wedge-shaped bevel (44) of the plunger element (36) and the funnel-shaped hollow (43) of the face (39) of the valve-seat member (5) and is deformed into a funnel shape by the action of the plunger element (36).

9. The fuel injector as recited in one of claims 1 through 8, wherein a radially outer edge (41) of the swirl disk (34) is clamped between the valve-seat member (5) and a guide disk (42).

10. The fuel injector as recited in one of claims 1 through 9, wherein the swirl of the fuel flowing through the fuel injector (1) is intensified by an axial displacement of the plunger element (36) in the downstream direction and is weakened by an axial displacement of the plunger element (36) against the downstream direction.

11. The fuel injector as recited in one of claims 1 through 10, wherein the axial position of the plunger element (36) is adjustable independently of a lift of the valve needle (3).
